(19) United States
(12) Patent Application Publication
(10) Pub. No.: US 2024/0057603 A1
(43) Pub. Date: Feb. 22, 2024

(54) ISOCYCLOSERAM FORMULATION

(71) Applicant: SYNGENTA CROP PROTECTION AG, Basel (CH)

(72) Inventors: Stephen ROE, Bracknell, Berkshire (GB); Floriane HOUILLON, Bracknell, Berkshire (GB); Beverley MASON, Bracknell, Berkshire (GB); Clair STUART, Bracknell, Berkshire (GB)

(73) Assignee: SYNGENTA CROP PROTECTION AG, Basel (CH)

(21) Appl. No.: 18/257,974

(22) PCT Filed: Dec. 13, 2021
(86) PCT No.: PCT/EP2021/085480

§ 371 Date: Jun. 16, 2023

(30) Foreign Application Priority Data
Dec. 18, 2020 (EP) 20215262.5

(51) Int. Cl. A01N 43/80

(52) U.S. Cl. CPC A01N 43/80

(57) ABSTRACT

This invention relates to a composition comprising: (a) isocycloseram, (b) a polyoxyalkylene copolymer, (c) an acrylic graft copolymer, and (d) an oxygenated hydrocarbon compound.

This invention relates to a composition comprising isocycloseram. More particularly, this invention relates to millbases, or to formulations such as suspension concentrates (SC), flowable suspensions (FS), suspoemulsions (SE), suspension concentrate-capsule suspension blends (ZC), ready-to-use baits (RB), water soluble granules (SG), water dispersible granules (WG), and water dispersible tablets (WT); to dilutions or dispersions of such formulations more particularly in a farmer's spray-tank; and to use of such a composition to combating and/or control an animal pest.

Isocycloseram is an insecticidal agrochemical, and is more particularly a solid at room temperature (25° C.). It is convenient to prepare isocycloseram as a fine suspension of dispersed particles in a liquid medium, typically by milling isocycloseram to produce a millbase which may then be further processed by the addition of other ingredients or even by a drying stage.

However, it has been found that with isocycloseram, conventional millbase approaches present a number of problems, such as for example millbases are difficult to make at large-scale processing (especially at a manufacturing site) due to the poor wetting of isocycloseram, and it was observed that millbases increased in viscosity when exposed to changing temperatures (for example when exposed to freeze/thaw cycles).

The aim of the present invention is to overcome the problems of the prior art techniques by proposing a composition comprising isocycloseram, guaranteeing a temperature stability when exposed to changing temperatures, while being easy to process at a large-scale.

To this end, an object of the present invention is to provide a composition comprising:
(a) isocycloseram,
(b) a polyoxyalkylene copolymer,
(c) an acrylic graft copolymer, and
(d) an oxygenated hydrocarbon compound.

Thanks to the combination of (b), (c) and (d) with isocycloseram, all the above problems have been overcome.

The composition of the present invention can comprise from 0.01% to 70% by weight of isocycloseram, preferably from 0.1% to 70% by weight of isocycloseram, preferably from 5% to 70% by weight of isocycloseram, preferably from 10% to 70% by weight of isocycloseram, preferably from 20% to 60% by weight of isocycloseram, and more preferably from 40% to 60% by weight of isocycloseram, over the total weight of the composition.

Isocycloseram is an insecticidal agrochemical with the following CAS number: 2061933-85-3, and has the following chemical formula:

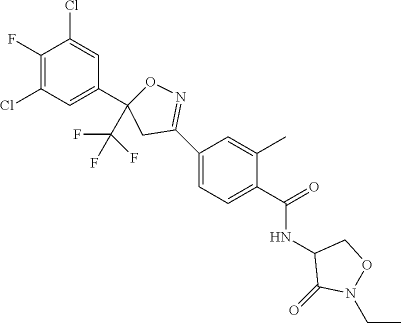 [SMILES: CCN1OCC(NC(=O)c2ccc(C3=NOC(c4cc(Cl)c(F)c(Cl)c4)(C(F)(F)F)C3)cc2C)C1=O]

Isocycloseram is more particularly a solid at room temperature (25° C.), and has a low aqueous solubility, which is typically less than 5 mg/l at 20° C.

More particularly, the melting point of isocycloseram may be from 135 to 150° C., preferably from 138 to 148° C., and more preferably of 141±2° C.

The melting point of isocycloseram is conventionally obtained using Differential Scanning calorimetry (DSC) with a heating rate of 10° C./minute.

Isocycloseram can comprise the isomer (5S,4R) which is 4-[(5S)-5-(3,5-dichloro-4-fluoro-phenyl)-5-(trifluoromethyl)-4H-isoxazol-3-yl]-N-[(4R)-2-ethyl-3-oxo-isoxazolidin-4-yl]-2-methyl-benzamide, and optionally at least one of the isomers selected among isomer (5S,4S), isomer (5R,4R), isomer (5R,4S), and any combinations thereof. In the present invention, the isomer (5S,4S) is 4-[(5S)-5-(3,5-dichloro-4-fluoro-phenyl)-5-(trifluoromethyl)-4H-isoxazol-3-yl]-N-[(4S)-2-ethyl-3-oxo-isoxazolidin-4-yl]-2-methyl-benzamide; the isomer (5R,4R) is 4-[(5R)-5-(3,5-dichloro-4-fluoro-phenyl)-5-(trifluoromethyl)-4H-isoxazol-3-yl]-N-[(4R)-2-ethyl-3-oxo-isoxazolidin-4-yl]-2-methyl-benzamide; and the isomer (5R,4S) is 4-[(5R)-5-(3,5-dichloro-4-fluoro-phenyl)-5-(trifluoromethyl)-4H-isoxazol-3-yl]-N-[(4S)-2-ethyl-3-oxo-isoxazolidin-4-yl]-2-methyl-benzamide. When isocycloseram further comprises at least one of the isomers selected among isomer (5S,4S), isomer (5R,4R), isomer (5R,4S), and any combinations thereof, isocycloseram can comprise a molar proportion of the isomer (5S,4R) greater than 50%, e.g. at least 55%, 60%, 65%, 70%, 75%, 80%, 85%, 90%, 95%, 96%, 97%, 98% or 99%, over the total amount of the isomers (5 S,4R), (5S,4S), (5R,4R) and (5R,4S).

The composition of the present invention can comprise from 0.0005% to 50% by weight of the polyoxyalkylene copolymer, preferably from 0.1% to 30% by weight of the polyoxyalkylene copolymer, and preferably from 1% to 20% by weight of the polyoxyalkylene copolymer, over the total weight of the composition.

In the present invention, the polyoxyalkylene copolymer can be obtained from at least two different alkylene oxides, such as from ethylene oxide and propylene oxide monomers.

The polyoxyalkylene copolymer can be more preferably a polyoxyalkylene block copolymer of the AB, ABA, BAB, or ABABA type.

More particularly, the polyoxyalkylene copolymer can be prepared by ring-opening polymerization of the corresponding cyclic ethylene oxide and propylene oxide monomers.

Typically, the ring-opening polymerization is initiated by addition of water and alkali hydroxides, such as sodium hydroxide and potassium hydroxide. The block structure of the copolymer is formed by first polymerizing a polymer block using one monomer, before adding a second monomer to form further polymer blocks.

In a preferred embodiment, the polyoxyalkylene copolymer can be an ethylene oxide-propylene oxide-ethylene oxide block copolymer (EO-PO-EO block copolymer), or in other words a poly(ethylene oxide)-poly(propylene oxide)-poly(ethylene oxide) block copolymer or a poly(ethylene glycol)-poly(propylene glycol)-poly(ethylene glycol) block copolymer.

The polyoxyalkylene copolymer of the invention, and more particularly the EO-PO-EO block copolymer, can have a molecular weight from 1,000 to 15,000 g/mol, and more preferably from 3,000 to 7,000 g/mol.

In the present invention, the expression “a molecular weight” means an average molecular weight (i.e. a molecular weight approximately of). Molecular weight of a polymer, or in other words the molar mass, can be easily determined by method well-known in the art, such as gel permeation chromatography (GPC).

In a first embodiment, the EO-PO-EO block copolymer can have a polypropylene oxide molecular weight from 900 to 4,000 g/mol, and preferably from 2,000 to 4,000 g/mol. In other words, the polypropylene oxide molecular weight is the molecular weight of the poly(propylene oxide) block of the EO-PO-EO block copolymer.

In a second embodiment, the EO-PO-EO block copolymer can have an ethylene oxide content from 10 to 80%, and preferably from 30 to 50%, over the total weight of the copolymer.

In other words, the ethylene oxide content is the percentage of the poly(ethylene oxide) block in the EO-PO-EO block copolymer.

In a third embodiment, the EO-PO-EO block copolymer can have the features of the first embodiment and the features of the second embodiment.

Examples include the GENAPOL® PF series (CLARIANT), the PLURONIC® series (BASF), the SYNPERONIC® PE series (CRODA), or the TOXIMUL® series (STEPAN).

The composition of the present invention can comprise from 0.0005% to 30% by weight of the acrylic graft copolymer, preferably from 0.01% to 30% by weight of the acrylic graft copolymer, and more preferably from 0.1% to 20% by weight of the acrylic graft copolymer, over the total weight of the composition.

The acrylic graft copolymer has typically a comb- or star-like structure, and preferably a comb-like structure.

Graft copolymers are branched copolymers wherein the components forming the side chains are structurally different from the components forming the main chain.

Comb-like polymers comprise of a main chain (backbone) which contains branch points from each of which a linear side chain emanates.

Star-like polymers comprise of a multifunctional centre from which at least three polymer chains radiate.

In a preferred embodiment, the acrylic graft copolymer can be an amphipathic copolymer.

More particularly, the acrylic graft copolymer comprises at least one component A, which is solvated by an aqueous medium (hydrophilic part), and at least one other component B which is hydrophobic.

Suitable acrylic graft copolymers may comprise polyethylene glycol, mono-methyl ethers of polyethylene glycol, poly(vinyl pyrrolidone), poly(acrylamide) or poly(vinyl alcohol) as hydrophilic side chain, while the hydrophobic backbone may comprise polymers and copolymers of styrene, methyl acrylate, methyl methacrylate, ethyl acrylate, 2-ethylhexyl acrylate, lauryl methacrylate, or vinyl acetate.

Such acrylic graft copolymers can for example be prepared by converting the mono-methyl ether of a polyethylene glycol to the acrylic or methacrylic ester, which is then subjected to radical polymerization with other unsaturated monomers such as styrene, ethyl acrylate, or methyl methacrylate. It is also possible to prepare such acrylic graft copolymers by reacting a hydrophobic polymer backbone, which consists chemically reactive sites such as carboxyl, hydroxy, or amine groups, with monomeric alkylene oxides, such as ethylene oxide and propylene oxide, to form hydrophilic side chains.

More preferably, the acrylic graft copolymer is a non-ionic polymer, and more particularly with a comb-like structure.

In the present invention, the acrylic graft copolymer can comprise polyethylene glycol and/or mono-ether polyethylene glycol side chains.

The acrylic graft copolymer can also comprise a backbone obtained from acrylate and/or methacrylate monomers.

Even more preferably, the acrylic graft copolymer can comprise a backbone obtained from acrylate and/or methacrylate monomers, and side chains comprising polyethylene glycol and/or mono-ether polyethylene glycol, giving more particularly the polymer a comb-like structure.

For example, the acrylic graft copolymer of the present invention can be Atlox 4913™ supplied by CRODA, or Tersperse 2500™ supplied by HUNTSMAN.

The composition of the present invention can comprise from 0.0001% to 30% by weight of the oxygenated hydrocarbon compound, preferably from 0.01% to 30% by weight of the oxygenated hydrocarbon compound, and more preferably from 0.1% to 20% by weight of the oxygenated hydrocarbon compound, over the total weight of the composition.

The oxygenated hydrocarbon compound can be selected among alkyl ether compounds, alkyl ester compounds, and any mixture thereof; and preferably among polyethylene glycol alkyl ether, sulfonated alkyl ester compounds, and any mixture thereof. In other words, the oxygenated hydrocarbon compound (d) is preferably different from the polyoxyalkylene copolymer (b) and from the acrylic graft copolymer (c).

The polyethylene glycol alkyl ether can be obtained by reacting alcohols with ethylene oxide. Suitable alcohols are linear or branched aliphatic alcohols with a chain length from C₂ to C₁₅, preferably with a chain length from C₇ to C₁₁, and more preferably with a chain length of C₉ or C₁₀. An example can be Rhodasurf DA/630-E™ supplied by SOLVAY-RHODIA,

The sulfonated alkyl ester compound can be a sulfosuccinate ester or a salt of a sulfosuccinate ester. An example can be Aerosol™ OT-B, supplied by SOLVAY-RHODIA.

In the present invention, the composition may further comprise water.

In a particular embodiment of the present invention, especially to form a millbase, the composition may comprise:
(a) from 20 to 70% by weight of isocycloseram, and more preferably from 30 to 60% by weight of isocycloseram, over the total weight of the composition,
(b) a polyoxyalkylene copolymer, preferably from 0.1% to 10.0% by weight of the polyoxyalkylene copolymer, and more preferably from 1.0% to 4.0% by weight of the polyoxyalkylene copolymer, over the total weight of the composition.
(c) an acrylic graft copolymer, preferably from 0.1% to 10.0% by weight of the acrylic graft copolymer, and more preferably from 0.2% to 2.0% by weight of the acrylic graft copolymer, over the total weight of the composition.
(d) an oxygenated hydrocarbon compound, preferably from 0.01% to 10.0% by weight of the oxygenated hydrocarbon compound, and more preferably from 0.1% to 2.0% by weight of the oxygenated hydrocarbon compound, over the total weight of the composition, and
(e) optionally water.

In said particular embodiment, the isocycloseram, the polyoxyalkylene copolymer, the acrylic graft copolymer and the oxygenated hydrocarbon are the compounds described in the present description.

In another particular embodiment of the present invention, especially to form formulations such as a suspension concentrate (SC), a flowable suspension (FS), a suspoemulsion (SE), a suspension concentrate-capsule suspension blend (ZC), a ready-to-use bait (RB), water soluble granules (SG), water dispersible granules (WG), and water dispersible tablets (WT), the composition may comprise:
(a) from 0.01% to 50.0% by weight of isocycloseram, and more preferably from 0.1% to 40.0% by weight of isocycloseram, over the total weight of the composition,
(b) a polyoxyalkylene copolymer, preferably from 0.0005% to 50.0% by weight of polyoxyalkylene copolymer, and more preferably from 0.002% to 25.0% by weight of polyoxyalkylene copolymer, over the total weight of the composition,
(c) an acrylic graft copolymer, preferably from 0.0005% to 20.0% by weight of the acrylic graft polymer and more preferably from 0.001% to 10.0% by weight of the acrylic graft polymer, over the total weight of the composition,
(d) an oxygenated hydrocarbon compound, preferably from 0.0001% to 10.0% by weight of the oxygenated hydrocarbon compound, and more preferably from 0.001% to 5.0% by weight of the oxygenated hydrocarbon compound, over the total weight of the composition, and
(e) optionally water.

In said particular embodiment, the isocycloseram, the polyoxyalkylene copolymer, the acrylic graft copolymer and the oxygenated hydrocarbon are the compounds described in the present description.

The composition of the present invention may further comprise one or more formulation additives well-known in the art. In particular, the formulation additives can be selected among an anti-freeze agent, an anti-foam agent, an anti-bacterial agent (or biocide), a viscosity modifier (or thickener), a pH modifier, and any mixture thereof.

In a preferred embodiment, the composition of the present invention can further comprise at least a silicone compound as anti-foam agent. Examples of silicone compounds can be polydimethylsiloxane.

The anti-foam agent can be added in an appropriate amount in the composition, to obtain the desired property. For example, the composition of the present invention can comprise from 0.0001% to 5% by weight of anti-foam agent, preferably from 0.0001% to 1% by weight of anti-foam agent, and more preferably from 0.01% to 1% by weight of anti-foam agent, over the total weight of the composition.

Other suitable formulation additives include amongst others known to the person skilled in the art, antioxidant, emulsifying agent, colourant (or pigment), perfume, adjuvant, attractant, binder, buffer, solid support (carrier), coating agent, deodorant, emetic agent, inorganic filler, safener, organic solvent, photo-protecting agent, and any mixture thereof.

The composition of the present invention may further comprise an additional agrochemical. The additional agrochemical can be an insecticide, a fungicide, an herbicide, a synergist, a plant growth regulator, a nematicide, a plant nutrient, a plant fertilizer, and a mixture thereof.

In a particular embodiment, the composition of the present invention can comprise an additional insecticide selected among abamectin, chlorantraniliprole, chlorfenapyr, cyantraniliprole, emamectin benzoate, ethiprole, gamma-cyhalothrin, lambda-cyhalothrin, lufenuron, methoxyfenozide, pymetrozine, spinetoram, spinosad, sulfoxaflor, thiamethoxam, and any mixtures thereof; and more preferably can comprise an additional insecticide selected among chlorantraniliprole, chlorfenapyr, cyantraniliprole, emamectin benzoate, ethiprole, lambda-cyhalothrin, lufenuron, spinosad, and any mixtures thereof. The weight ratio of isocycloseram to additional insecticide can be from 1:100 to 100:1, preferably from 1:20 to 20:1, preferably from 1:10 to 10:1, preferably from 1:1 to 1:10, and more preferably from 1:1 to 1:6.

When using emamectin benzoate as additional insecticide, a photo-protecting agent can be preferably added to the composition.

The composition of the present invention may comprise a suitable amount of one or several of the above-mentioned ingredient(s) to obtain the respective properties, when appropriate.

In another object of the present invention, the composition can be advantageously used to prepare a suspension concentrate (SC), a flowable suspension (FS), a suspoemulsion (SE), a suspension concentrate-capsule suspension blend (ZC), a ready-to-use bait (RB), water soluble granules (SG), water dispersible granules, or water dispersible tablets (WT).

In a particular embodiment, the composition of the present invention may relate to:
a concentrate designed to be added to a farmer's spray tank of water or it may be applied directly without further dilution, or
a suspension produced in a farmer's spray tank of water when a concentrate is mixed with water in the spray tank.

In another object of the present invention, the present invention relates to a method of combating and/or controlling an animal pest, which comprises applying to the pest, to a locus of the pest, or to a plant susceptible to attack by the pest, the composition according to the present invention.

The animal pest can be an invertebrate animal pest, such as insects, acarines, nematodes or molluscs. The term “plant” as used herein includes seedlings, bushes and trees.

The composition according to the present invention can be used for combating and/or controlling (i.e. containing or destroying) pests of the abovementioned type which occur in particular on plants, especially on useful plants and ornamentals in agriculture, in horticulture and in forests, or on organs, such as fruits, flowers, foliage, stalks, tubers or roots, of such plants, and in some cases even plant organs which are formed at a later point in time remain protected against these pests.

Suitable target crops are, in particular, cereals, such as wheat, barley, rye, oats, rice, maize (e.g. field corn, popcorn, corn), millet or sorghum; beet, such as sugar or fodder beet; fruit, for example pomaceous fruit, stone fruit or soft fruit, such as apples, pears, plums, peaches, almonds, cherries or berries, for example strawberries, raspberries or blackberries; leguminous crops, such as beans, lentils, peas or soya (soya beans); oil crops, such as oilseed rape, mustard, poppies, olives, sunflowers, coconut, castor, cocoa or ground nuts; cucurbits, such as pumpkins, cucumbers, melons, watermelons, cucumbers or squashes; fibre plants, such as cotton, flax, hemp or jute; citrus fruit, such as oranges, lemons, grapefruit or tangerines; vegetables, such as spinach, lettuce, asparagus, cabbages, broccolis, cauliflowers, carrots, onions, tomatoes, potatoes or bell peppers; Lauraceae, such as avocado, Cinnamonium or camphor; and also tobacco, nuts, coffee, eggplants, sugarcane, tea, pepper, grapevines, hops, the plantain family and latex plant.

In this method, the composition can be generally applied with an effective amount of isocycloseram.

More preferably, said method is applied in spraying the composition of the present invention, for example dispensed from a spray container.

Said method can involve an effective amount of the composition applied at a rate of from 0.01 to 5 Litre per Hectare (L/ha), and more preferably from 0.02 to 3.0 L/ha.

In another object of the present invention, the composition can be a seed treatment formulation, or in other words a plant propagation material can be treated with the composition according to the invention. The term “plant propagation material” is understood to denote all the generative parts of the plant, such as seeds, which can be used for the multiplication of the latter including vegetative plant material such as cuttings. There may be mentioned, as plant propagation material, seeds (in the strict sense), roots, fruits, tubers, bulbs, rhizomes, parts of plants. The plant propagation material can be treated with the composition of the invention before the material is sown or planted. Alternatively, the plant propagation material may be treated with the composition of the invention during sowing or planting. Additionally, the composition of the invention may be applied to the previously treated propagation material before or during its planting. The composition of the invention may be applied during the sowing of the seed. The composition may also be used to plant propagation material derived from plants grown in a green house and/or during transplantation. Said seed treatment formulation can be applied with rates ranging of from 10 mg to 1 g of active substance (isocycloseram) per kg of seeds, preferably from 10 mg to 500 mg of active substance (isocycloseram) per kg of seeds, and more preferably from 10 mg to 100 mg of active substance (isocycloseram) per kg of seeds.

In another object of the present invention, the composition may also be used as animal health treatment.

The following non-limiting examples demonstrate the improved behaviour associated with a composition according to the present invention.

The compounds used in the following examples are detailed below.
Isocycloseram is an insecticide which is solid at room temperature (25° C.), and has a melting point of 141±2° C. (CAS number: 2061933-85-3).
Pluronic™ PE 10400 is an EO-PO-EO block copolymer (CAS Number: 9003-11-6), supplied by BASF.
Atlox™ 4913-LQ-(MV) is a solution comprising around 35% by weight of an acrylic graft copolymer, supplied by CRODA.
Rhodasurf DA/630-E is a polyethylene glycol alkyl ether (CAS Number: 78330-20-8), supplied by SOLVAY-RHODIA.
Aerosol™ OT-B contains a mixture of sodium dioctyl sulfosuccinate (80-90%) and sodium benzoate (15-20%), supplied by SOLVAY-RHODIA.

### EXAMPLE 1

This example provides a composition, according to the present invention, which is a millbase (i.e. isocycloseram millbase) and which may be used to prepare further compositions or formulations according to the present invention. The millbase of Example 1 can include well-known formulation additives such as viscosity modifier, biocide and anti-foam agent.

Water and biocide were added to a double-jacketed formulation vessel and stirring with a sawtooth mixer started at ambient temperature (20° C.). A viscosity modifier was added quickly, and the mixture was kept stirring until the viscosity modifier had fully dispersed and no lumps were visible anymore. An anti-foam agent, Rhodasurf DA/630-E, Atlox™ 4913-LQ-(MV), and Pluronic™ PE 10400 (as a 25% solution in water) were added, in the given order, while continuing mixing. The vessel was connected to a chiller unit and cooled down to 10° C. and then isocycloseram was added to the vessel.

When isocycloseram had been completely wetted, high shear mixing (Silverson high-shear mixer, 5000 rpm) commenced. The mixture was sheared continuously until it was found to be able to pass through a 150 μm sieve. The mixture was then transferred to a horizontal bead mill and milled until the following median particle size was achieved: D(v,50)<2 μm with 70% below 3 μm (measured with a Malvern Mastersizer 2000, laser diffraction particle size analyser).

The concentrations of the components added to form the isocycloseram millbase of Example 1 are listed in the below Table 1, and are expressed in percentage by weight over the total weight of the isocycloseram millbase (% w/w).

TABLE 1

| | | Con- |
|---|---|---|
| | | centra- |
| | | tion |
| | | (% |
| Component | Chemical type | w/w) |
| Isocycloseram | | 50.0 |
| Pluronic ™ PE 10400 | Polyoxyalkylene copolymer (b) | 2.5 |
| Atlox ™ 4913-LQ-(MV) | Acrylic graft copolymer (c) in | 2.5 |
| | solution | |
| Rhodasurf DA/630-E | Oxygenated hydrocarbon | 1.0 |
| | compound (d) | |
| Viscosity modifier | | 0.1 |
| Biocide | | 0.05 |
| Anti-foam agent | | 0.3 |
| Water | | ad 100 |
| | | (rest) |

### EXAMPLE 2

This example provides a suspension concentrate according to the present invention. The following components were added to a vessel in the following order: water, biocide, anti-freeze, and viscosity modifier were mixed with a paddle stirrer, and then the isocycloseram millbase from Example 1 was added. The resulting composition was mixed for 1 hour under low shear using a paddle stirrer. The pH was adjusted to target (pH 5) using an acidifier (pH modifier). The biocide, the anti-freeze, the viscosity modifier and the pH modifier added to form the suspension concentrate are well-known formulation additives.

The concentrations of the components added to form the suspension concentrate of Example 2 are listed in the below Table 2, and are expressed in percentage by weight over the total volume of the suspension concentrate (% w/v).

TABLE 2

| | Concentration |
|---|---|
| Component | (% w/v) |
| Isocycloseram millbase | 80 |
| (Example 1) | |
| Biocide | 0.31 |
| Anti-freeze | 5 |
| Viscosity modifier | 0.21 |
| pH modifier (acidifier) | ad pH 5 |
| Water | ad volume (rest) |

### EXAMPLES 3-13

A 50 ml glass beaker with an inner diameter of 40 mm was charged with 5 g of an aqueous solution of Pluronic PE 10400, Atlox 4913-LQ-(MV), Rhodasurf DA/630E and Aerosol OT-B, with the concentration of the individual ingredients as given in below Table 3. To said solution, 5 g of isocycloseram was added within 10 sec. The beaker was left undisturbed. The wetting of the solid isocycloseram was visually assessed after 1 min, 2 min and 8 min.

A sample was rated as completely wetted when no isocycloseram was floating on top of the liquid anymore, and all of the isocycloseram had sunken to the bottom of the beaker.

The concentrations of the components in Examples 3-13, expressed in percentage by weight over the total weight of the composition (% w/w), as well as the wetting assessment are gathered in Table 3.

TABLE 3

| | Composition | | | | | | | | |
|---|---|---|---|---|---|---|---|---|---|
| | Pluronic | Atlox 4913- | Rhodasurf | Aerosol | | | | | |
| | PE 10400 | LQ-(MV) | DA/630E | OT-B | Isocycloseram | | Wetting assessment | | |
| Ex. | (% w/w) | (% w/w) | (% w/w) | (% w/w) | (% w/w) | Water | 1 min | 2 min | 8 min |
| 3 | 5 | | | | 50 | ad 100 | incomplete | incomplete | incomplete |
| 4 | 5 | | 1 | | 50 | ad 100 | incomplete | complete | complete |
| 5 | 2.5 | 2.5 | | | 50 | ad 100 | incomplete | incomplete | incomplete |
| 6 | 2.5 | 2.5 | 1 | | 50 | ad 100 | complete | complete | complete |
| 7 | | 5 | | | 50 | ad 100 | incomplete | incomplete | incomplete |
| 8 | | 5 | 1 | | 50 | ad 100 | complete | complete | complete |
| 9 | | | 1 | | 50 | ad 100 | incomplete | incomplete | complete |
| 10 | 2.5 | 2.5 | | 1 | 50 | ad 100 | complete | complete | complete |
| 11 | 5 | | | 1 | 50 | ad 100 | incomplete | complete | complete |
| 12 | | 5 | | 1 | 50 | ad 100 | incomplete | incomplete | complete |
| 13 | | | | 1 | 50 | ad 100 | incomplete | incomplete | complete |

### EXAMPLES 14-23

To prepare 10 g of a given millbase, a 30 ml glass jar was charged with the ingredients according to the compositions stated in below Table 4. First, Pluronic PE 10400, Atlox 491-LQ-(MV), Rhodasurf DA/630E, and Aerosol OT-B were dissolved in water. Then an anti-foam agent (a formulation additive well-known in the art) and Isocycloseram were added. Finally, 15 ml of zirconium silicate beads (Type Z, 0.8-1.0 mm diameter) were added, for wet milling. The jar was shaken for 15 min at 30 s⁻¹ using a Retsch MM200 shaker mill. The jar was left undisturbed for 75 min to cool down, before it was shaken for another 15 min at s⁻¹. Afterwards, the sample was left to cool down before it was poured through a sieve (150 μm) to remove the zirconium silicate beads. To check the efficiency of the milling process, the particle size was measured using a Malvern Mastersizer 2000 laser diffraction particle size analyser. A satisfying milling process provides a D[4,3] particle size (D[4,3] being well-known as De Brouckere mean diameter or volume-weighted mean diameter) from 1 to 10 μm, and preferably from 1 to 5 μm.

The concentrations of the components in Examples 14-23, expressed in percentage by weight over the total weight of the composition (% w/w), as well as the particle size are gathered in Table 4.

TABLE 4

| | Composition | | | | | | | |
|---|---|---|---|---|---|---|---|---|
| | Pluronic | Atlox 4913- | Rhodasurf | Aerosol | Anti-foam | | | Particle |
| | PE 10400 | LQ-(MV) | DA/630E | OT-B | agent | Isocycloseram | | Size |
| Example | (% w/w) | (% w/w) | (% w/w) | (% w/w) | (% w/w) | (% w/w) | Water | D[4,3] |
| 14 | 5 | | | | 0.25 | 50 | ad 100 | 2.4 μm |
| 15 | 5 | | 1 | | 0.25 | 50 | ad 100 | 2.5 μm |
| 16 | 2.5 | 2.5 | | | 0.25 | 50 | ad 100 | 2.2 μm |
| 17 | 2.5 | 2.5 | 1 | | 0.25 | 50 | ad 100 | 2.9 μm |
| 18 | | 5 | | | 0.25 | 50 | ad 100 | 2.7 μm |
| 19 | | 5 | 1 | | 0.25 | 50 | ad 100 | 2.5 μm |
| 20 | 5 | | | 1 | 0.25 | 50 | ad 100 | 2.5 μm |
| 21 | 2.5 | 2.5 | | 1 | 0.25 | 50 | ad 100 | 2.7 μm |
| 22 | | | | 1 | 0.25 | 50 | ad 100 | 2.6 μm |
| 23 | | | 1 | | 0.25 | 50 | ad 100 | 9.1 μm |

To evaluate the temperature-stability of the samples (Examples 14-23), the viscosity of the samples was measured at varying temperatures. The viscosity of the samples was determined using an Anton-Parr MCR 502 rheometer, equipped with a CC17 cup and bob geometry. While rotating the bob with a constant shear stress of 10 Pa, the temperature was first lowered from 20° C. to −10° C. at a rate of 0.5° C./min, before it was brought up to 60° C. at a rate of 0.5° C./min.

When reducing the temperature, the viscosity of a sample is expected to increase until the sample reaches its freezing point. When increasing the temperature, the viscosity is expected to decrease. Any event leading to an increase of the viscosity while increasing the temperature indicates the failure of the dispersant system, which can be accompanied by irreversible aggregation of the solid particles.

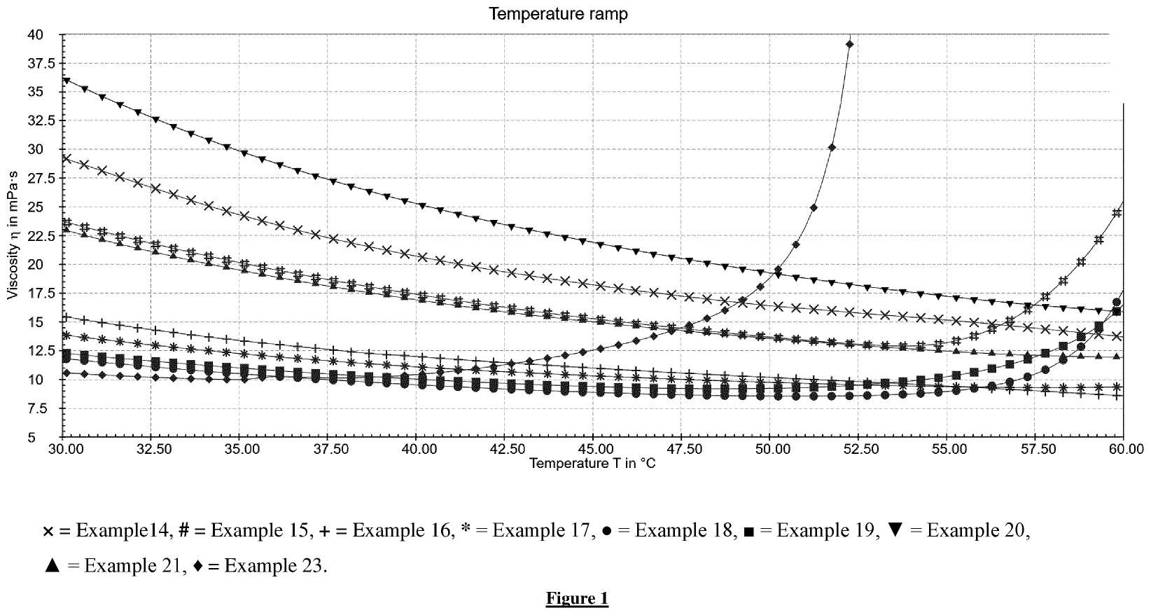

The results for Examples 14-23 are shown in FIG. 1. More particularly, when increasing the temperature from 25° C. to 60° C., the examples 17 and 21 according to the invention present stable viscosity up to 60° C., or in other words said examples 17 and 21 did not show an increase in viscosity especially above 40° C. in comparison with examples 15, 18, 19, and 23 (see FIG. 1).

Example 22 is not represented in FIG. 1 as its viscosity had not decreased anymore when increasing the temperature from −10° C. to 25° C., so that it could not be measured in the range presented in FIG. 1.

Hence, it stems from the above that the examples 6, 10, 17 and 21 according to the present invention demonstrate the importance of the combination of a polyoxyalkylene copolymer (b), an acrylic graft copolymer (c), and an oxygenated hydrocarbon compound (d), for the wetting of isocycloseram allowing advantageously to process at a large-scale the composition, while guaranteeing a temperature stability of the composition.

1. A composition comprising:
(a) isocycloseram,
(b) a polyoxyalkylene copolymer,
(c) an acrylic graft copolymer, and
(d) an oxygenated hydrocarbon compound.

2. A composition as claimed in claim 1, characterized in that it comprises from 0.01% to 70% by weight of isocycloseram, preferably 0.1% to 70% by weight of isocycloseram, and more preferably from 5% to 60% by weight of isocycloseram, over the total weight of the composition.

3. A composition as claimed in claim 1, characterized in that it comprises from 0.0005% to 50% by weight of the polyoxyalkylene copolymer, and preferably from 1.0% to 20% by weight of the polyoxyalkylene copolymer, over the total weight of the composition.

4. A composition according to claim 1, characterized in that it comprises from 0.0005% to 30% by weight of the acrylic graft copolymer, and preferably from 0.1% to 20% by weight of the acrylic graft copolymer, over the total weight of the composition.

5. A composition according to claim 1, characterized in that it comprises from 0.0001% to 30% by weight of the oxygenated hydrocarbon compound, and preferably from 0.1% to 20% by weight of the oxygenated hydrocarbon compound, over the total weight of the composition.

6. A composition according to claim 1, characterized in that the polyoxyalkylene copolymer is obtained from ethylene oxide and propylene oxide monomers.

7. A composition according to claim 1, characterized in that the polyoxyalkylene copolymer is a poly(ethylene oxide)-poly(propylene oxide)-poly(ethylene oxide) block copolymer.

8. A composition according to claim 1, characterized in that the polyoxyalkylene copolymer has a molecular weight from 1,000 to 15,000 g/mol, and preferably from 3,000 to 7,000 g/mol.

9. A composition according to claim 1, characterized in that the acrylic graft copolymer comprises polyethylene glycol and/or mono-ether polyethylene glycol side chains.

10. A composition according to claim 1, characterized in that the acrylic graft copolymer comprises a backbone obtained from acrylate and/or methacrylate monomers.

11. A composition according to claim 1, characterized in that the oxygenated hydrocarbon compound is selected among alkyl ether compounds, alkyl ester compounds, and any mixture thereof.

12. A composition according to claim 1, characterized in that the oxygenated hydrocarbon compound is selected among polyethylene glycol alkyl ether, sulfonated alkyl ester compounds, and any mixture thereof.

13. A composition according to claim 1, characterized in that it further comprises one or more formulation additives selected among an anti-freeze agent, an anti-foam agent, an anti-bacterial agent (or biocide), a viscosity modifier, a pH modifier, and any mixture thereof.

14. A composition according to claim 1, characterized in that it is used to prepare a suspension concentrate, a flowable suspension, a suspoemulsion, a suspension concentrate-capsule suspension blend, a ready-to-use bait, water soluble granules, water dispersible granules, or water dispersible tablets.

15. A method of combating and/or controlling an animal pest, which comprises applying to the pest, to a locus of the pest, or to a plant susceptible to attack by the pest, the composition according to claim 1.
